(19) United States
(12) Patent Application Publication
(10) Pub. No.: US 2014/0025473 A1
(43) Pub. Date: Jan. 23, 2014

(54) CROWDFUNDING BASED ON ACTIONS

(71) Applicant: Jedidiah S. Cohen, New York, NY (US)

(72) Inventor: Jedidiah S. Cohen, New York, NY (US)

(73) Assignee: RocketHub Inc., New York, NY (US)

(21) Appl. No.: 13/552,688

(22) Filed: Jul. 19, 2012

(51) Int. Cl. G06Q 20/10; G06Q 30/02

(52) U.S. Cl. 705/14.28; 705/39

(57) ABSTRACT

A crowdfunding platform can receive an indication that an entity has completed an action. Examples of an entity include a funder, a campaign account owner, a third party and a combination thereof. Examples of actions include making a purchase, subscribing to a service, joining an entity's social network, etc. Upon receiving the indication, an account (e.g., a crowdfund account such as a funder and/or campaign account) can be credited with a value that can correspond to the completion of the action. Value can be transferred from an external account (such as travel rewards program, an external virtual currency account, etc.) to a crowdfund account and vice versa. If the transferor account is denominated in a different unit of value than the transferee account, an exchange rate can be determined and applied to the transaction.

### BACKGROUND

The present disclosure relates to crowdfunding, and more specifically to crowdfunding based on actions by users and others.

Crowdfunding sites provide mechanisms for fundraisers to solicit funding from the general public and/or other sources to fund an enterprise. A source of funding (a “funder”) can view information about an enterprise on the crowdfunding site and decide to make a contribution (or investment) to fund the enterprise. Information about an enterprise can include background information about the fundraisers, the objectives of the enterprise, funding goals, consideration by the enterprise for funders, etc. For example, a fundraiser can be a musical group seeking to fund the enterprise of mounting a tour. The information about such an enterprise can include information about members of the band, the prospective tour schedule, samples of music by the band, a video pitch for funding by members of the band, etc. The band may offer a discount on concert tickets to funders as consideration for funding its campaign to mount a tour. A campaign includes a funding effort mounted by a fundraiser, where raised funds are deposited in a campaign account. A funder may have more than one campaign and campaign account.

A funder may wish to fund a campaign in ways other than transferring currency to the campaign account.

### SUMMARY

In accordance with various implementations, a crowdfunding platform can receive a confirmation that an entity has completed an action. Examples of an entity include a funder, a campaign account owner and a third party. Examples of actions include making a purchase, subscribing to a service, joining an entity's social network, etc. Upon receiving the confirmation, an account (e.g., a crowdfund account such as a funder and/or campaign account) can be credited with a value that can correspond to the completion of the action. In various implementations, value can be transferred from an external account (such as an airline, hotel or rental car rewards program) to a crowdfund account and vice versa. If the transferor account is denominated in a different unit of value than the transferee account, an exchange rate can be determined and applied to the transaction.

### BRIEF DESCRIPTION OF THE DRAWINGS

FIG. 1 shows a flowchart of a process in accordance with an implementation of the disclosed subject matter.

FIG. 2 shows a computer according to an implementation of the disclosed subject matter.

FIG. 3 shows a network configuration according to an implementation of the disclosed subject matter.

FIG. 4 shows a system in accordance with an implementation of the disclosed subject matter.

### DETAILED DESCRIPTION

In accordance with various implementations, an account of a crowdfunding platform can be credited when an entity completes an action. The entity can be a funder, a fundraiser or a third party. All or part of an amount credited to a user account can be utilized to fund a campaign.

An action can include, without limitation, a purchase of a product by the funder, by the fundraiser or by another. For example, a manufacturer or a retailer can issue a promotion that causes the user account (e.g., a funder account, a fundraiser account, a campaign account, etc.) to be credited a certain amount when the user (a funder, a fundraiser, a third party, etc.) purchases an item or combination of different items, a minimum number of items, a minimum value of items, makes the purchase within a given time window and/or from a particular source. For example, a user may receive five credits when the user purchases an airline class upgrade, completes a stay at a hotel, purchases an automobile, etc. Likewise, the account may be credited two dollars when the user buys at least three boxes of tissue or when the user spends at least fifty dollars at a restaurant. Also, the account may be credited five percent of the purchase value of a particular type of perfume, up to a maximum of twenty five dollars. The action can have a time-based component. For example, an account may be credited when a user makes any purchase at a store on a Tuesday or Wednesday, subscribes to a service before a given date and/or time, etc.

An account can be denonimated in actual or virtual currency. An actual currency is a medium of exchange issued by or on behalf of a sovereign government. Examples of actual currency include dollars, euros, Swiss francs, kroner, etc. Virtual currency can include a medium of exchange issued by or on behalf of an entity other than a sovereign government. Examples of virtual currency include in-game currency such as Station Cash in Everquest II published by Sony Online Entertainment, virtual world currency such as Linden Dollars used in Second Life by Linden Lab, Facebook Credits, electronic cash such as Bitcoin, etc.

An action can include completing a survey. The amount credited can depend on the answers given by the user to the survey. For example, completing all of the questions in the survey can result in a greater amount being deposited in the account than partially completing the survey.

An action can include changing a membership in a social network. For example, an account can be credited when a user “likes” or “follows” a given entity on a social network, such as Facebook or Twitter, or joins a social network of an entity (a person, a company, a product, etc.) Likewise, an action can include mentioning an entity in a blog or on a social network. Changing a membership in a social network can include changing the state of a social network in any way.

An action can also include signing up for a service, such as Netflix, subscribing to an Internet Service Provider (ISP) service, obtaining a membership to a fitness club, etc. An action can include accepting an offer, such as an offer to apply for a credit card, to purchase a given product, etc.

In accordance with various implementations of the presently disclosed subject matter, rewards programs can be a source of funding for a user account. For example, airline frequent flyer points, hotel points, rental car points, external virtual currency accounts (e.g., Station Cash, Linden Dollars, Bitcoin, etc.) and the like can be converted into funding for a user account. A request can be received from the a user to convert a given amount of points in a rewards program account into an actual or virtual currency deposit into a crowdfund user account, such as a funder account, a campaign account, etc. The given amount of reward points can be deducted from the rewards program account. An exchange rate can be determined between rewards points and a denomination of the crowdfund account, either in a virtual currency or an actual currency. For example, each frequent flyer point may be worth 3 virtual currency units, $0.01, etc., in the crowdfund account. The amount to be credited to the user account can be calculated based on the amount of rewards points being redeemed and the exchange rate. For example, if a user wishes to convert 1200 rewards points into crowdfund virtual currency, 1200 rewards points can be deducted from his rewards account and, assuming an exchange rate of 3 crowdfund virtual currency units per reward point, 3600 virtual currency units can be deposited in the user's crowdfund account. A denomination can be the units in which value stored in an account is expressed. For example, an account can store value denominated in dollars, pounds, points, virtual currency units, etc.

In another implementation, the amount to deposit into the crowdfund account can be set, an exchange rate can be determined, and the correct number of rewards points to deduct from the rewards account can be calculated. The calculated number of rewards points can be deducted from the rewards account and the correct amount can be deposited into the crowdfund account. For example, a user specifies that $300 be deposited in his crowdfund account based on his points in a rewards account. The exchange rate between rewards points and dollars can be determined to be $0.03 per reward point. In that case, it can be determined that 10,000 rewards points should be deducted from the rewards account for $300 to be deposited in the crowdfund user account.

Likewise, in various implementations, crowdfund account credit (e.g., actual currency, virtual currency, other carriers of value) can be converted back into rewards account or other account credits.

The amounts deducted from one account and/or credited to another account can be subject to fees that can be charged by the crowdfund platform and/or other service providers. For example, a percentage of funds transferred or a fixed fee can be charged when funds are credited to and/or debited from a crowdfund account. The fee can be imposed in transferring value from an external account (such as a rewards account) into a crowdfund account and/or vice versa. A fee can be imposed in transferring value from one crowdfund account to another, e.g., from a funder account to a campaign account. The fee can be charged to the transferor, the transferee or both. The fee can be charged by deducting the amount deposited into the destination account or charged separately.

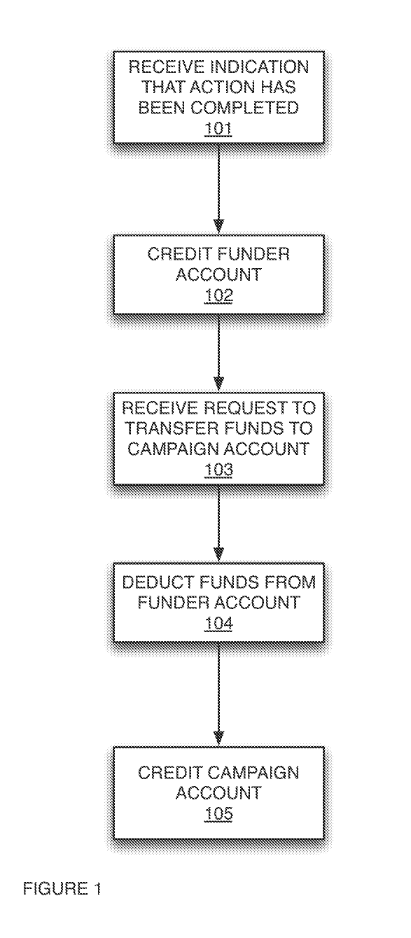

FIG. 1 shows a flowchart of a process in accordance with an implementation of the disclosed subject matter. An indication is received that an entity has completed a given action, 101. In response, the crowdfunding system can credit a user's (e.g., a funder's) account, 102. The user may be the same as, or different than, the entity that completed the action. For example, the user can make a purchase in conjunction with a promotion and the user account can be credited. The user can refer another person to, for example, the user's health club. When the other person signs up to become a member of the health club, the user's account can be credited. When the user and three other persons purchase a package vacation together, the user's account can be credited. The system can receive a user's request to transfer value from the user account to a campaign account, 103. The value can be denominated in a virtual currency, an actual currency, etc. The amount can be deducted from the user account, 104. The campaign account can be credited an amount equal to, less than or greater than the amount deducted from the user account, 105. For example, the campaign account can be credited an amount equal to the amount deducted from the user account, less a fee charged for the transaction by the crowdfunding platform. Likewise, the campaign account can be credited a bonus amount in addition to the amount deducted from the user's account.

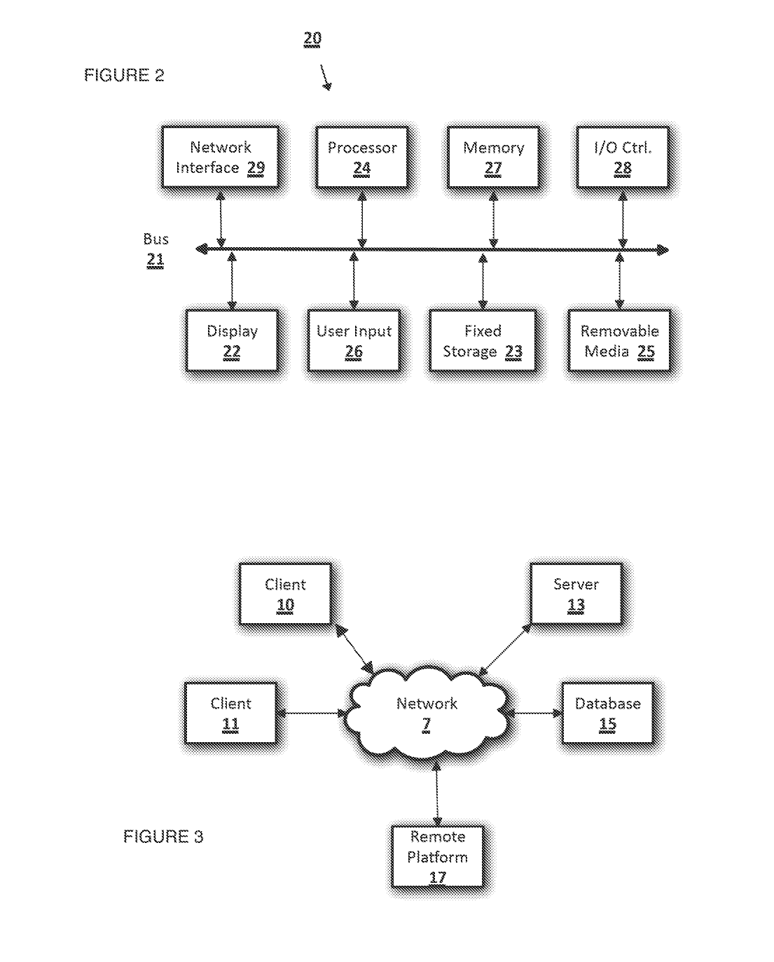

Implementations of the presently disclosed subject matter may be implemented in and used with a variety of component and network architectures. FIG. 2 is an example computer 20 suitable for implementing the presently disclosed subject matter. The computer 20 includes one or more of: a bus 21 which interconnects major components of the computer 20, a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like. The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) that controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an Internet Service Provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 3.

Many other devices or components (not shown) may be connected in a similar manner (e.g., document scanners, digital cameras and so on). Conversely, all of the components shown in FIG. 2 need not be present to practice the present disclosure. The components can be interconnected in different ways from that shown. The operation of a computer such as that shown in FIG. 2 is readily known in the art and is not discussed in detail in this application. Code to implement the present disclosure can be stored in computer-readable storage media such as one or more of the memory 27, fixed storage 23, removable media 25, or on a remote storage location.

FIG. 3 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

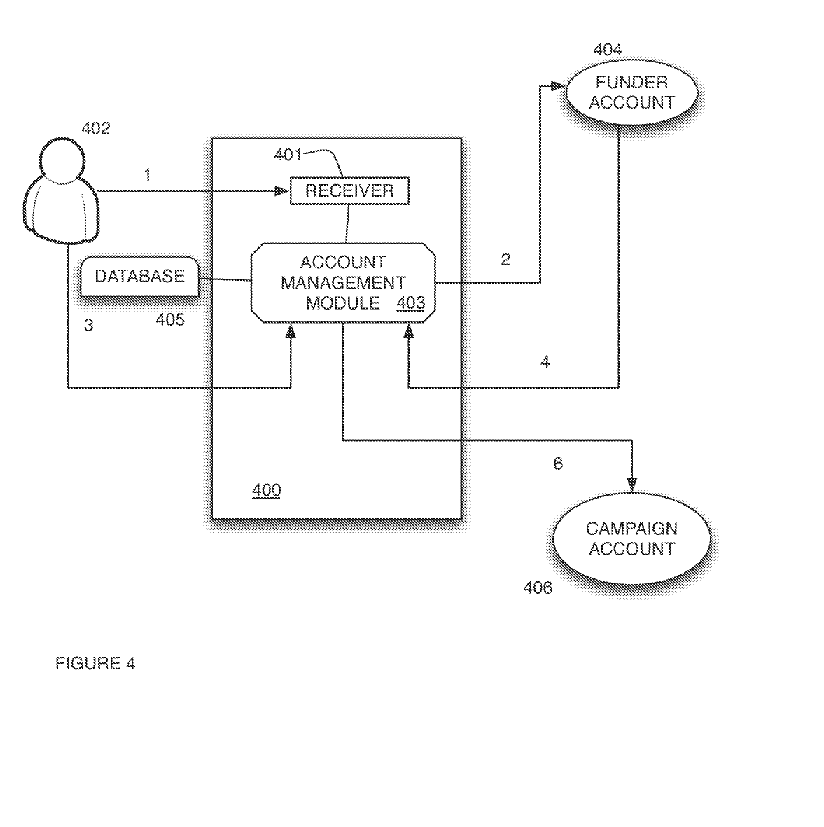

FIG. 4 shows a system in accordance with an embodiment of the disclosed subject matter. Receiver 401 receives an indication that funder 402 has completed an action. Account management module 403 credits the funder account 404 an amount based on the completion of the action. The amount to be credited can be obtained from database 405. The account management module 403 can receive a request from funder 402 to transfer a value from the funder account 404 to campaign account 406. The account management module 403 can deduct an amount from the funder account 404 and credit an amount to the campaign account, 406. The amount credited to the campaign account 406 can be the same, equal to or less than the amount deducted from the funder account 404. The account management module 403 can charge a transaction fee to the funder account 404, the campaign account 406 or to a third party account (not shown.)

The foregoing description for purpose of explanation, have been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

What is claimed is:

1. A method, comprising:
receiving an indication that an entity has completed an action;
crediting a funder account with an amount corresponding to the completion of the action;
receiving a request from a funder to transfer a funding amount from the funder account to a campaign account; and
deducting at least the funding amount from the funder account; and
crediting a campaign amount to the campaign account, the campaign amount based on the funding amount.

2. The method of claim 1, further comprising deducting a fee from at least one selected from the group of: the funder account, the campaign account and a third party account.

3. The method of claim 1, wherein the action is at least one selected from the group consisting of: subscribing to a service, enrolling in a membership, applying for a credit card and adding an entity to a social network.

4. The method of claim 1, wherein the action includes at least one selected from the group consisting of: purchasing a product, completing a survey, changing a membership in a social network, enrolling in a membership service, applying for a credit card and subscribing to a service.

5. The method of claim 4, wherein changing a membership in a social network includes at least one selected from the group consisting of: following a member on Twitter, mentioning an entity on a social network and adding a member to a social network.

6. The method of claim 1, wherein the action includes sending a request to transfer value from a rewards account having a first denomination to the funder account having a second denomination, the request specifying the value in the first denomination to be deducted from the rewards account and wherein the crediting the funder account with an amount corresponding to the completion of the action comprises:
determining an exchange rate between the first denomination of the rewards account and the second denomination of the funder account; and
calculating amount to credit the funder account based on the amount of rewards points and the exchange rate.

7. The method of claim 1, wherein the action includes sending a request to transfer value to the funder account having a second denomination from a rewards account having a first denomination, the request specifying the value in the second denomination to be credited to the funder account and wherein the crediting the funder account with an amount corresponding to the completion of the action comprises:
determining an exchange rate between the first denomination of the rewards account and the second denomination of the funder account; and
calculating amount to deduct from the rewards account based on the amount to be credited to the funder account and the exchange rate.

8. The method of claim 1, wherein the action includes sending a request to transfer value between a rewards program having a first denomination to the funder account.

9. The method of claim 7, wherein the amount credited to the campaign account is denominated in a virtual currency.

10. The method of claim 8, wherein the rewards account is associated with at least one selected from the group consisting of: a travel rewards program and a credit card rewards program.

11. A system, comprising:
a receiver that receives an indication that an entity has completed an action;
an account management module that credits a funder account with an amount corresponding to the completion of the action, receives a request from a funder to transfer a funding amount from the funder account to a campaign account, deducts at least the funding amount from the funder account and credits the funding amount to the campaign account; and
a database that stores account information including the balance of the funder account and the balance of the campaign account.

12. The system of claim 11, wherein the action includes at least one selected from the group of: purchasing a product and completing a survey.

13. The system of claim 11, wherein the action includes at least one selected from the group consisting of liking an entity on Facebook, following an entity on Twitter, mentioning an entity on Facebook and mentioning an entity on Twitter.

14. The system of claim 11, wherein the action includes at least one selected from the group consisting of: enrolling in a membership service and applying for an exclusive service.

15. The system of claim 11, further comprising a transfer processing module that receives a request to transfer value from a rewards account having a first denomination to the funder account having a second denomination, the request specifying the value in the first denomination to be deducted from the rewards account, determines an exchange rate between the first denomination of the rewards account and the second denomination of the funder account and calculates amount to credit the funder account based on the amount of rewards points and the exchange rate.

16. The system of claim 11, further comprising a transfer processing module that receives a request to transfer value to the funder account having a second denomination from a rewards account having a first denomination, the request specifying the value in the second denomination to be credited to the funder account, determines an exchange rate between the first denomination of the rewards account and the second denomination of the funder account and calculates an amount to deduct from the rewards account based on the amount to the funder account and the exchange rate.

17. The system of claim 11, wherein the action is a request to transfer a value between a rewards account and a funder account, the rewards account being associate with at least one selected from the group consisting of: a points program and a credit card rewards program.

18. The system of claim 17, wherein the rewards account includes virtual currency.

19. The system of claim 11, wherein the amount credited to the funder account is denominated in a virtual currency.
